(19) United States
(12) Patent Application Publication
(10) Pub. No.: US 2020/0034739 A1
(43) Pub. Date: Jan. 30, 2020

(54) METHOD AND DEVICE FOR ESTIMATING USER'S PHYSICAL CONDITION

(71) Applicant: Samsung Electronics Co., Ltd., Suwon-si (KR)

(72) Inventors: Gihsung CHUNG, Suwon-si (KR); Jonghee HAN, Suwon-si (KR); Joonho KIM, Suwon-si (KR); Sangbae PARK, Suwon-si (KR); Mira YU, Suwon-si (KR)

(21) Appl. No.: 16/508,961

(22) Filed: Jul. 11, 2019

(30) Foreign Application Priority Data
Jul. 25, 2018 (KR) 10-2018-0086764

(51) Int. Cl. G06N 20/00; G06N 5/02

(52) U.S. Cl. CPC G06N 20/00; G06N 3/08; G06N 5/02

(57) ABSTRACT

An artificial intelligence (AI) system capable of imitating functions of the human brain, such as recognition, determination, etc., using a machine learning algorithm such as deep learning, and an application is provided. The AI system device, configured to estimate a user's physical condition, may receive first biometric data obtained by a wearable device worn by the user from the wearable device, obtain first sensing data for estimation of the user's physical condition via a sensor included in the device, and train a trained model for estimating the user's physical condition based on an artificial intelligence algorithm and by using the received first biometric data and the obtained first sensing data as training data.

### CROSS-REFERENCE TO RELATED APPLICATION(S)

This application is based on and claims priority under 35 U.S.C. § 119(a) of a Korean patent application number 10-2018-0086764, filed on Jul. 25, 2018, in the Korean Intellectual Property Office, the disclosure of which is incorporated by reference herein in its entirety.

### BACKGROUND

### 1. Field

The disclosure relates to a method and device for estimating a user's physical condition.

### 2. Description of Related Art

Artificial intelligence (AI) systems are computer systems capable of achieving human level intelligence, and capable of training itself, deciding, and becoming smarter, unlike existing rule-based smart systems. As use of such AI systems increases, recognition rates thereof further improve and users' preferences can be more accurately understood. Accordingly, the existing rule-based smart systems are gradually being replaced with deep-learning-based AI systems.

AI technology consists of machine learning (for example, deep learning) and element technologies using the machine learning. Machine learning is an algorithm technology capable of self-sorting/learning features of input data. The element technologies are technologies for simulating functions of the human brain such as recognition, determination, etc., by using a machine learning algorithm such as deep learning, and consist of technical fields, including linguistic comprehension, visual comprehension, inference/prediction, knowledge representation, motion control, etc.

Various fields to which AI technology is applicable will be described below. One field, linguistic comprehension, is a technique for identifying and applying/processing human language/characters, and includes natural-language processing, machine translation, dialogue systems, query and response, speech recognition/synthesis, etc. Another field, visual comprehension, is a technique for identifying and processing things in terms of human perspective, and includes object recognition, object tracking, image searching, identification of human beings, scene comprehension, space comprehension, image enhancement, etc. Another field, inference prediction, is a technique for identifying and logically reasoning information and making predictions, and includes knowledge/probability-based reasoning, optimization prediction, preference-based planning, recommendation, etc. Another field, knowledge representation, is a technique for automatically processing human experience information according to knowledge data, and includes knowledge building (data generation/classification), knowledge management (data utilization), etc. Another field, motion control, is a technique for controlling self-driving of a vehicle and a robot's movement, and includes motion control (navigation, collision avoidance, traveling, etc.), operation control (behavior control), etc.

Consideration can also be given to other devices, such as wearable devices that are capable of measuring a user's physical condition. For example, wearable devices are capable of measuring a user's heart rate, blood pressure, body temperature, oxygen saturation, electrocardiogram, respiration, pulse waves, ballistocardiogram, etc.

Such wearable devices are capable of measuring a user's physical condition when worn on the user's body. Therefore, these wearable devices are limited in that they should be worn on a user's body to measure the user's physical condition. Due to the limitation of these wearable devices, there is a growing need for devices capable of measurements, such as measuring or estimating a user's physical condition, when not in contact with the user's body.

However, the accuracy of information estimated when a device is not in contact with a user's body may be lower than that of data actually measured. This is because the information estimated when the device is not in contact with the user's body may be influenced by external factors. Accordingly, a method and device capable of more accurately estimating a user's physical condition when a device is not in contact with the user's body is needed.

The above information is presented as background information only, and to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages, and to provide at least the advantages described below. Accordingly, an aspect of the disclosure is to provide a method and device for estimating a user's physical condition. Aspects of the disclosure are not limited thereto, and other aspects may be derived from embodiments which will be described below.

Additional aspects will be set forth in part in the description which follows and, in part, will be apparent from the description, or may be learned by practice of the presented embodiments of the disclosure.

In accordance with an aspect of the disclosure, a method is provided to estimate a condition without physical contact. The method, of estimating a user's physical condition performed by a device, includes receiving first biometric data from a wearable device worn by the user, the first biometric data being obtained by the wearable device, obtaining first sensing data by a sensor included in the device, the first sensing data being used for estimation of the user's physical condition, and training a trained model for estimating the user's physical condition based on an artificial intelligence algorithm and by using the received first biometric data and the obtained first sensing data as training data, wherein the sensor obtains the first sensing data while not in contact with the user's body.

In accordance with another aspect of the disclosure, the training of the trained model for estimating the user's physical condition may include obtaining second sensing data related to the user's physical condition from the first sensing data by inputting the first biometric data and the first sensing data to a certain filter, and using the first sensing data and the second sensing data as the training data. The filter may obtain the second sensing data related to the user's physical condition from the first sensing data by using the first biometric data.

In accordance with another aspect of the disclosure, the method may further include preprocessing the first sensing data. The obtaining of the second sensing data may include obtaining the second sensing data by inputting the first biometric data and the preprocessed first sensing data to the filter.

In accordance with another aspect of the disclosure, a device for estimating a user's physical condition is provided. The device includes a communication interface configured to establish short-range wireless communication, a memory storing one or more instructions, and at least one processor configured to execute the one or more instructions to estimate the user's physical condition. The at least one processor is further configured to execute the one or more instructions to receive first biometric data obtained by a wearable device worn by the user from the wearable device, obtain first sensing data, which is to be used for estimation of the user's physical condition, by using a sensor included in the device, and train a trained model for estimating the user's physical condition based on the received first biometric data and the obtained first sensing data as training data. The sensor obtains the first sensing data while not in contact with the user's body.

In accordance with another aspect of the disclosure, there is provided a computer-readable recording medium having recorded thereon a program for executing the above method in a computer.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a situation in which a user's physical condition is estimated using a device according to an embodiment of the disclosure;

FIG. 2 is a flowchart of a training method of a trained model for estimating a user's physical condition, the training method being performed by a device according to an embodiment of the disclosure;

FIG. 3 is a flowchart of a training method of a trained model for estimating a user's physical condition by using a certain filter, the training method being performed by a device according to an embodiment of the disclosure;

FIG. 4 is a flowchart of a training method of a trained model for preprocessing data to be input to a certain filter and estimating a user's physical condition based on the preprocessed data, the training method being performed by a device according to an embodiment of the disclosure;

FIG. 5 is a flowchart of a training method of a trained model for selecting a wearable device and estimating a user's physical condition based on data received from the selected wearable device, the training method being performed by a device according to an embodiment of the disclosure;

FIG. 6 is a flowchart of a method of estimating a user's physical condition by using a further trained model, the method being performed by a device according to an embodiment of the disclosure;

FIG. 7 is a diagram illustrating an example of training a trained model for estimating a user's physical condition by a device, according to an embodiment of the disclosure;

FIG. 8 is a diagram illustrating another example of training a trained model for estimating a user's physical condition by a device, according to an embodiment of the disclosure;

FIG. 9 is a diagram illustrating an example of estimating a user's physical condition using a further trained model, by a device according to an embodiment of the disclosure;

FIG. 10 is a diagram illustrating a situation in which a trained model for estimating a user's physical condition is trained by a device according to an embodiment of the disclosure; and

FIG. 11 is a block diagram illustrating a structure of a device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used to enable a clear and consistent understanding of the disclosure. Accordingly, it should be apparent to those skilled in the art that the following description of various embodiments of the disclosure is provided for illustration purpose only, and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Like reference numerals represent like elements throughout the specification. All elements of embodiments of the disclosure are not described in the present specification, and matters well-known in the technical field to which the disclosure pertains or same matters of the embodiments are not described redundantly herein. As used herein, the term “module” or “unit” may be embodied as one or more of software, hardware, or firmware. In embodiments of the disclosure, a plurality of “modules” or “units” may be embodied as one element or one “module” or “unit” may include a plurality of elements.

Throughout the disclosure, the expression “at least one of a, b or c” indicates only a, only b, only c, both a and b, both a and c, both b and c, all of a, b, and c, or other variations thereof.

Hereinafter, operating principles of the disclosure and embodiments thereof will be described with reference to the accompanying drawings.

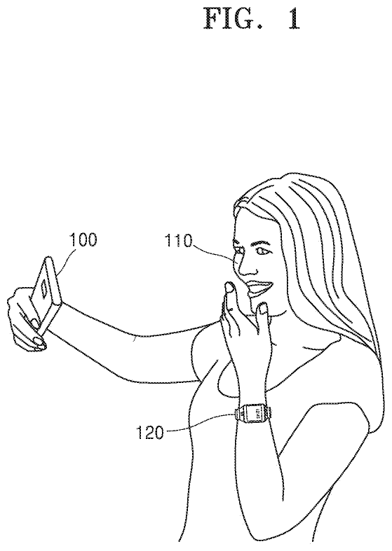

FIG. 1 is a diagram illustrating a situation in which a user's physical condition is estimated using a device according to an embodiment of the disclosure.

FIG. 1 illustrates a situation in which a mobile device 100 estimates, for example, a user's heart rate, but embodiments are not limited thereto.

Referring to FIG. 1, the mobile device 100 may photograph a user's face 110 by using a camera. In doing so, the mobile device 100 may obtain a face image of the user while not in contact with the user's body. The face image of the user is an image representing the user's face 110, and may be an image including the user's face 110 therein. Alternatively, the face image of the user may be an image including therein the user's body, a background, etc., together with the user's face 110.

The mobile device 100 may analyze a change of the skin color of the user's face 110 based on the obtained face image of the user. The mobile device 100 may then estimate the user's heart rate based on a result of analyzing the change of the skin color of the user's face 110.

The mobile device 100 may also estimate the user's heart rate by applying the face image of the user to a trained model for estimating a user's heart rate.

The trained model for estimating a user's heart rate may be trained by the mobile device 100 by using training data to increase the accuracy of estimation of the user's heart rate. The mobile device 100 may use the face image of the user as training data. Alternatively, the mobile device 100 may use heart rate information of the user received from a wearable device 120 as training data. The heart rate information of the user received from the wearable device 120 may be generated based on biometric data sensed by the wearable device 120 in contact with the user's body. The mobile device 100 may then use both the heart rate information of the user and the face image of the user as training data.

The trained model for estimating a user's heart rate may be trained by the mobile device 100 to more accurately estimate the user's heart rate than before the trained model is trained.

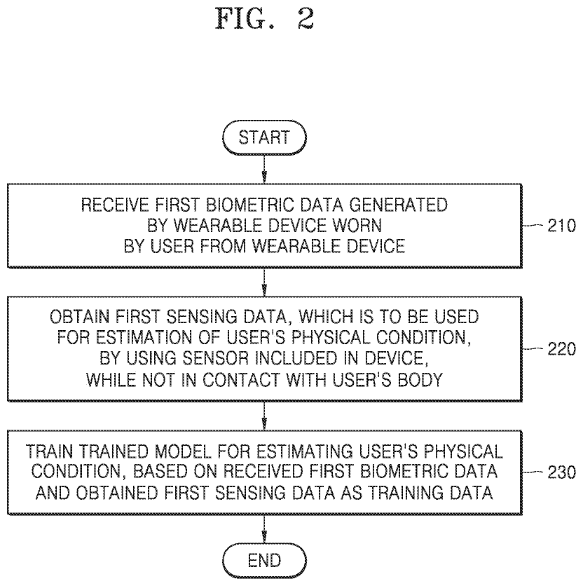

FIG. 2 is a flowchart of a training method of a trained model for estimating a user's physical condition, the training method being performed by a device according to an embodiment of the disclosure.

Referring to FIG. 2, in operation 210, the mobile device 100 may receive first biometric data generated by a wearable device worn by a user from the wearable device.

In one embodiment of the disclosure, the user's physical condition may include the user's heart rate, blood pressure, body temperature, oxygen saturation, electrocardiogram, respiration, pulse waves, ballistocardiogram, etc. The first biometric data may represent the user's physical condition. For example, the first biometric data may include data indicating the user's heart rate, blood pressure, body temperature, oxygen saturation, electrocardiogram, respiration, pulse waves, ballistocardiogram, etc.

In one embodiment of the disclosure, the wearable device worn by the user may include a smart watch, a Bluetooth earphone, a smart band, etc.

In one embodiment of the disclosure, the first biometric data may be generated by a device other than the wearable device. The device other than the wearable device is a device that the user does not wear on his or her body and that is capable of sensing the user's biometric data when in contact with the user's body. Hereinafter, for convenience of explanation, such a device other than a wearable device, which is capable of sensing data while in contact with a user's body, will also be referred to as a wearable device.

In one embodiment of the disclosure, the mobile device 100 may receive real-time heart rate information (e.g., 67 bpm) of the user, measured by a wearable device, as the first biometric data. The first biometric data may be data generated based on data sensed by the wearable device in contact with the user's body. For example, the first biometric data may be raw data sensed by the wearable device by using a sensor included in the wearable device. Further, for example, the first biometric data may be data calculated based on raw data sensed by a wearable device, and may be a numerical value indicating the user's physical condition.

In operation 220, the mobile device 100 may obtain first sensing data, which is to be used to estimate the user's physical condition, by using a sensor included therein, while not in contact with the user's body.

In one embodiment of the disclosure, the mobile device 100 may estimate the user's physical condition. The user's physical condition estimated by the mobile device 100 may include the user's heart rate, blood pressure, body temperature, oxygen saturation, electrocardiogram, respiration, pulse waves, ballistocardiogram, etc.

In one embodiment of the disclosure, the first sensing data obtained by the mobile device 100 may include an image, a radar signal, a capacitance change signal, a pressure change signal, or the like.

In one embodiment of the disclosure, the sensor included in the mobile device 100 may include a camera, a radar device, a capacitive sensor, a pressure sensor, etc.

When the mobile device 100 estimates the user's heart rate based on a change of the skin color of the user's face, the first sensing data may be a face image of the user. The mobile device 100 may obtain the face image of the user by using the camera included therein. The face image of the user may be obtained by the mobile device 100 not in contact with the user's body.

When the user's heart rate is estimated by radar, the first sensing data obtained by the mobile device 100 may be a radar signal. The mobile device 100 may transmit a radar signal to the user via a radar device. The transmitted radar signal may be reflected after reaching the user, and the mobile device 100 may receive the reflected radar signal as the first sensing data.

In one embodiment of the disclosure, the receiving of the first biometric data by the wearable device which is worn by the user in operation 210, and the obtaining of the first sensing data by the mobile device 100 in operation 220, may be performed within a certain time period.

The first biometric data and the first sensing data that are obtained within the time period may be data regarding the same physical condition of the user unless the user's physical condition changes within the time period.

In operation 230, a trained model for estimating a user's physical condition may be trained by the mobile device 100 based on the received first biometric data and the obtained first sensing data as training data.

In one embodiment of the disclosure, the trained model for estimating a user's physical condition may be a trained model for estimating a user's heart rate. When the mobile device 100 estimates the user's heart rate based on a change of the skin color of the user's face, the first sensing data may be a face image of the user. Alternatively, the first biometric data received by the mobile device 100 may be heart rate information of the user.

In one embodiment of the disclosure, the trained model for estimating a user's heart rate may be trained by the mobile device 100 based on the heart rate information of the user (the first biometric data) received from the wearable device and the face image of the user (the first sensing data) as training data.

The heart rate information of the user (the first biometric data) received by the mobile device 100 from the wearable device may be a type of ground truth. The trained model may be trained by the mobile device 100 by supervised learning performed using the received heart rate information of the user (the first biometric data) and the face image of the user (the first sensing data) as training data.

In one embodiment of the disclosure, a user may be identified by the mobile device 100, and one of a plurality of trained models stored in units of users to estimate a user's physical condition may be trained by the mobile device 100. A trained model corresponding to the identified user among the plurality of trained models for estimating a user's physical condition may be trained by the mobile device 100.

For example, the mobile device 100 may store a trained model for estimating a physical condition of a first user, and a trained model for estimating a physical condition of a second user. When the first user uses the mobile device 100, the first user may be identified by the mobile device 100. The trained model for estimating the physical condition of the first user corresponding to the identified first user among the plurality of trained models stored may be trained by the mobile device 100.

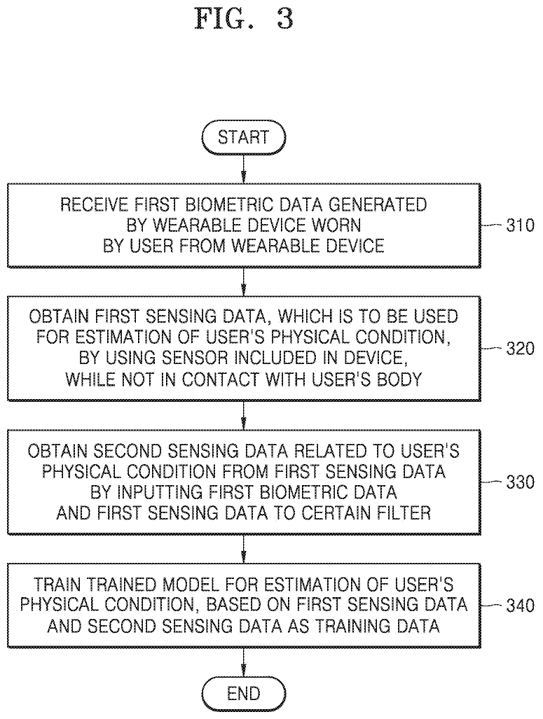

FIG. 3 is a flowchart of a training method of a trained model for estimating a user's physical condition by using a certain filter, the training method being performed by a device according to an embodiment of the disclosure.

Referring to FIG. 3, in operation 310, the mobile device 100 may receive first biometric data generated by a wearable device worn by a user from the wearable device.

In operation 320, the mobile device 100 may obtain first sensing data, which is to be used for estimation of the user's physical condition, by using a sensor included therein, while not in contact with the user's body.

In operation 330, the mobile device 100 may obtain second sensing data related to the user's physical condition from the first sensing data by inputting the first biometric data and the first sensing data to a certain filter.

In one embodiment of the disclosure, the mobile device 100 may input the user's heart rate information (the first biometric data) and a face image of the user (the first sensing data) to a certain filter included in the mobile device 100.

In one embodiment of the disclosure, the filter may be used by the mobile device 100 to generate training data to be input to a trained model for estimating a user's physical condition. The filter may obtain the second sensing data related to the user's heart rate from the face image of the user (the first sensing data) based on the heart rate information of the user (the first biometric data).

The obtaining of the data by the filter may be understood to mean extracting part of the data from data input thereto, outputting certain data using the input data, or the like.

The heart rate information of the user (the first biometric data) may be reference data for determining whether certain data is related to the user's heart rate by the mobile device 100. The mobile device 100 may use the heart rate information of the user (the first biometric data) as reference data to obtain the second sensing data related to the user's heart rate by using the filter.

The filter may obtain image data of a region of the face related to the user's heart rate (the second sensing data) from the face image (the first sensing data) based on the heart rate information of the user (the first biometric data). The region of the user's face related to the user's heart rate may be a region of the user's face, through which the mobile device 100 may easily sense a change of the skin color of the user's face. The region of the user's face through which the mobile device 100 may easily sense a change of the skin color of the user's face may be a region less influenced by external factors.

External factors may include an environment outside the mobile device 100, such as the brightness of external light, color temperature of the external light, a shadow cast on the user's face, etc. Alternatively, the external factors may include system noise occurring inside the mobile device 100, such as image sensor noise, power noise, etc.

In operation 340, a trained model for estimating the user's physical condition may be trained by the mobile device 100 based on the first sensing data and the second sensing data as training data.

In one embodiment of the disclosure, the first sensing data obtained by the mobile device 100 may be a face image of the user, and the second sensing data may be an image of a region of the user's face related to the user's heart rate.

A trained model for estimating a user's heart rate may be trained by the mobile device 100 based on the obtained face image of the user (the first sensing data) and the obtained image data of the region of the user's face as training data (the second sensing data).

The image data of the region of the user's face is data related to real-time heart rate information of the user (the second sensing data), and may be a type of ground truth. The trained model may be trained by the mobile device 100 by supervised learning performed using the face image of the user (the first sensing data) and the image data of the region of the user's face (the second sensing data) as training data.

With the further trained model, the region of the user's face related to the user's heart rate may be more accurately identified from the face image of the user (the first sensing data).

The trained model is a type of a data recognition model, and may be a pre-built model. For example, the trained model may be a model built in advance by receiving basic training data (e.g., a sample image, etc.).

The trained model may be built based on an artificial intelligence algorithm, in consideration of a field to which recognition models apply, a purpose of learning, the computer performance of the mobile device 100, etc. The artificial intelligence algorithm may include at least one of a machine learning algorithm, a neural network algorithm, a genetic algorithm, a deep-learning algorithm, or a classification algorithm. Alternatively, the trained model may be a model based on, for example, a neural network. For example, a model, such as a deep neural network (DNN), a recurrent neural network (RNN), or a bidirectional recurrent deep neural network (BRDNN), may be available as the trained model, but embodiments of the disclosure are not limited thereto.

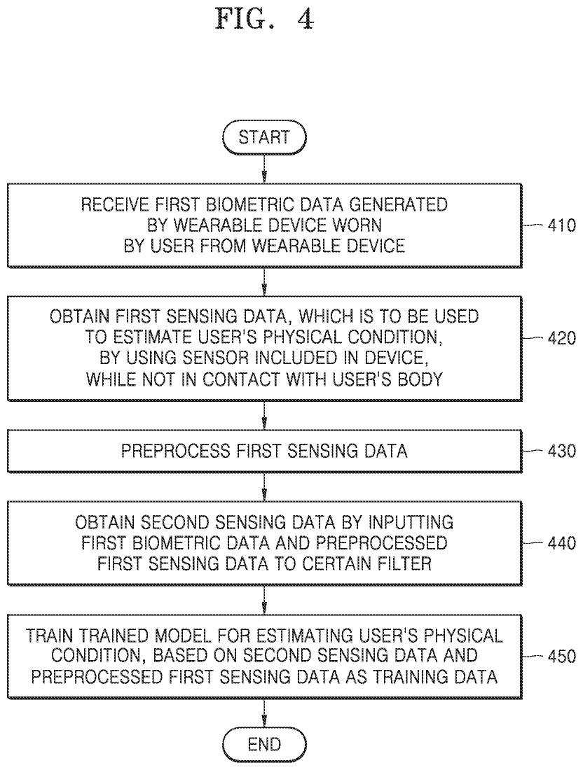

FIG. 4 is a flowchart of a training method of a trained model for preprocessing data to be input to a certain filter and estimating a user's physical condition based on the preprocessed data, the training method being performed by a device according to an embodiment of the disclosure.

Referring to FIG. 4, in operation 410, the mobile device 100 may receive first biometric data generated by a wearable device worn by a user from the wearable device.

In operation 420, the mobile device 100 may obtain first sensing data, which is to be used to estimate the user's physical condition, by using a sensor included therein while not in contact with the user's body.

In operation 430, the mobile device 100 may preprocess the first sensing data.

When the mobile device 100 estimates the user's heart rate based on a change of the skin color of the user's face, the first sensing data may be a face image of the user. The mobile device 100 may perform image signal processing on the face image of the user (the first sensing data).

The image signal processing may include face detection, face landmark detection, skin segmentation, flow tracking, frequency filtering, signal reconstruction, interpolation, color projection, etc.

The mobile device 100 may identify a face from the face image of the user (the first sensing data) by face detection. The mobile device 100 may exclude parts of the face image except the face based on a result of face detection. An image including only an image of the identified face may be generated. The image including only the image of the identified face will be hereinafter referred to as the image including only the face.

The mobile device 100 may generate a face image signal representing a change of red, green, blue (RGB) values of either the face image or the image including only the face. The face image signal generated by the mobile device 100 may include a waveform signal generated from the face image. The mobile device 100 may extract only image signals having a specific frequency by performing frequency filtering on the generated image signal.

The preprocessed first sensing data may include an image including only the face generated by the face recognition processing by the mobile device 100, a face image signal generated from the face image, a face image signal generated from the image including only the face, an image signal having a specific frequency extracted through frequency filtering, or the like.

In operation 440, the mobile device 100 may obtain second sensing data by inputting the first biometric data and the preprocessed first sensing data to a certain filter.

Operation 440 may be an operation in which the mobile device 100 inputs the preprocessed first sensing data to the filter instead of the first sensing data and obtains the second sensing data from the preprocessed first sensing data, compared to operation 330 of FIG. 3.

The first biometric data may correspond to the first biometric data received in operation 210 of FIG. 2. The first sensing data may correspond to the first sensing data obtained in operation 220 of FIG. 2.

In one embodiment of the disclosure, the mobile device 100 may input heart rate information of the user (the first biometric data) and an image including only the user's face (the preprocessed first sensing data) to a filter included in the mobile device 100.

In one embodiment of the disclosure, the filter may obtain second sensing data related to the user's heart rate from the image including only the user's face (the preprocessed first sensing data) based on the heart rate information of the user (first biometric data).

The filter may obtain image data of a region of a face related to the user's bit rate (the second sensing data) from the image including only the user's face (the preprocessed first sensing data) based on the heart rate information of the user (the first biometric data). The image data of the region of the face (the second sensing data) obtained from the image including only the user's face (the preprocessed first sensing data) may be image data of the image including only a region of the face related to the user's heart rate.

In one embodiment of the disclosure, the mobile device 100 may input the heart rate information of the user (the first biometric data) and the face image signal (the preprocessed first sensing data), which is generated from the face image of the user, to the filter included in the mobile device 100. In one embodiment of the disclosure, the filter may obtain the second sensing data related to the user's heart rate from the face image signal generated from the face image of the user (the preprocessed first sensing data) based on the heart rate information of the user (the first biometric data).

The filter may obtain a face image signal related to the user's heart rate (the second sensing data) from the face image signal generated from the face image of the user (the preprocessed first sensing data) based on the heart rate information of the user (the first biometric data).

The face image signal generated from the face image of the user (preprocessed first sensing data) may be a waveform signal generated from the face image of the user. The face image signal related to the user's heart rate (the second sensing data) may be a waveform signal of a specific frequency band extracted from the face image signal (the preprocessed first sensing data). The specific frequency band may be a frequency band including a frequency band corresponding to the user's heart rate.

In operation 450, a trained model for estimating a user's physical condition may be trained by the mobile device 100 based on the second sensing data and the preprocessed first sensing data as training data.

In one embodiment of the disclosure, a trained model for estimating a user's heart rate may be trained by the mobile device 100 based on the image data of the region of the user's face (the second sensing data) and the image including only the user's face (the preprocessed first sensing data) as training data.

In one embodiment of the disclosure, the trained model for estimating a user's heart rate may be trained by the mobile device 100 based on the face image signal related to the user's heart rate (the second sensing data) and the face image of the user (the preprocessed first sensing data) as training data.

The image including only the region of the user's face or the face image signal related to the user's heart rate (the second sensing data) is data related to real-time heart rate information of the user, and may be a type of ground truth. The trained model may be trained by the mobile device 100 by supervised learning performed using the image including only the region of the user's face (the second sensing data) and the image including only the user's face (the preprocessed first sensing data) as training data. Alternatively, the trained model may be trained by the mobile device 100 by supervised learning performed using the face image signal related to the user's heart rate (the second sensing data) and the face image of the user (the preprocessed first sensing data) as training data.

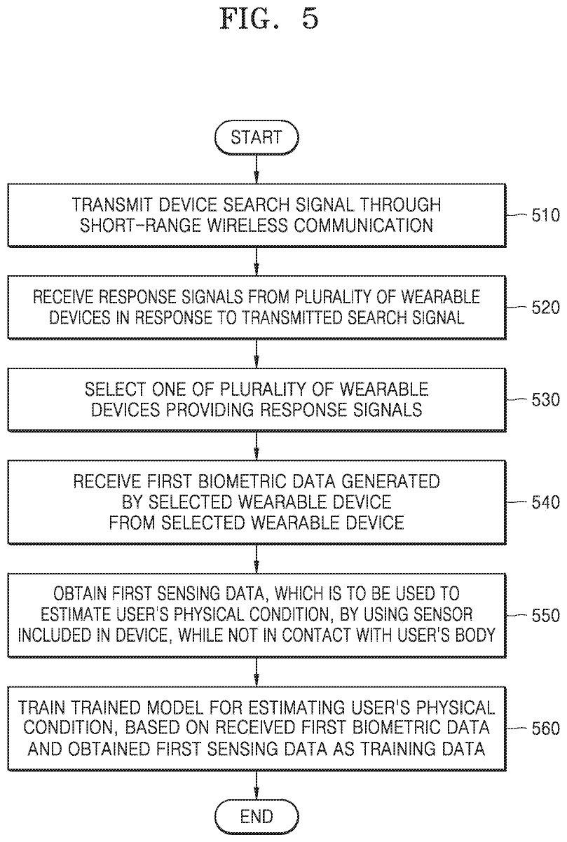

FIG. 5 is a flowchart of a training method of a trained model for selecting a wearable device and estimating a user's physical condition based on data received from the selected wearable device, the training method being performed by a device according to an embodiment of the disclosure.

Referring to FIG. 5, in operation 510, the mobile device 100 may transmit a device search signal through short-range wireless communication.

In one embodiment of the disclosure, the mobile device 100 may transmit the device search signal to a plurality of wearable devices through short-range wireless communication. The plurality of wearable devices may be wearable devices worn by a user.

In operation 520, the mobile device 100 may receive response signals from a plurality of wearable devices in response to the transmitted search signal.

In one embodiment of the disclosure, the mobile device 100 may receive response signals transmitted from a plurality of wearable devices worn by the user. The mobile device 100 may identify the plurality of wearable devices worn by the user based on the received response signals.

In operation 530, the mobile device 100 may select one or more of the plurality of wearable devices providing the response signals.

In one embodiment of the disclosure, the mobile device 100 may select a wearable device with a high degree of reliability of biometric data measurement from among a plurality of identified wearable devices. The mobile device 100 may also select a wearable device with a high degree of reliability of biometric data measurement from among a plurality of wearable devices identified based on a degree of closeness between each of the wearable devices and the user's skin, a type of first biometric data generated by each of the wearable devices, and the quality of a biometric signal obtained by each of the wearable devices and related to the first biometric data. In this case, the quality of the biological signal may be identified in consideration of noise included in the biological signal and the strength of the biological signal. For example, the quality of the biological signal may be identified based on a signal-to-noise ratio (SNR) of the biological signal.

In one embodiment of the disclosure, the mobile device 100 may select at least one device with a higher degree of reliability of biometric data measurement from among the plurality of identified wearable devices.

In operation 540, the mobile device 100 may receive first biometric data generated by the selected wearable device from the selected wearable device.

A degree of reliability of the first biometric data received from the selected wearable device may be higher than that of first biometric data received from each of the other non-selected wearable devices. Accordingly, a trained model for estimating the user's physical condition may be more effectively trained by the mobile device 100 by using, as training data, the first biometric data from the wearable device with the high reliability of biometric data measurement.

In operation 550, the mobile device 100 may obtain first sensing data, which is to be used to estimate the user's physical condition, by using a sensor included therein, while not in contact with the user's body.

In operation 560, a trained model for estimating a user's physical condition may be trained by the mobile device 100 based on the received first biometric data and the obtained first sensing data as training data.

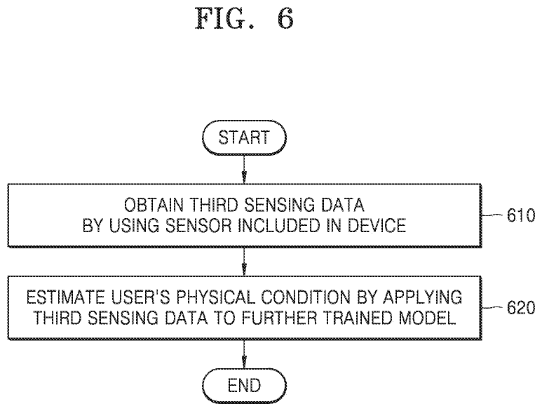

FIG. 6 is a flowchart of a method of estimating a user's physical condition by using a further trained model, the method being performed by a device according to an embodiment of the disclosure.

Referring to FIG. 6, in operation 610, the mobile device 100 may obtain third sensing data by using a sensor included therein.

In operation 620, the mobile device 100 may estimate a user's physical condition by applying the third sensing data to a further trained model.

The further trained model may be a trained model trained by one of the methods of training the trained model for estimating a user's physical condition which are described above with reference to FIGS. 2 to 5.

In one embodiment of the disclosure, the further trained model may be a trained model for estimating a user's heart rate. The mobile device 100 may estimate the user's heart rate by applying a face image of the user (the third sensing data) to the further trained model.

The further trained model may accurately estimate the user's physical condition, only based on the third sensing data, without having to receive first biometric data from a wearable device. Accordingly, the mobile device 100 may accurately estimate the user's physical condition by using the third sensing data obtained while not in contact with the user's body. In doing so, the mobile device 100 may allow the user to conveniently check an estimated value of his or her physical condition.

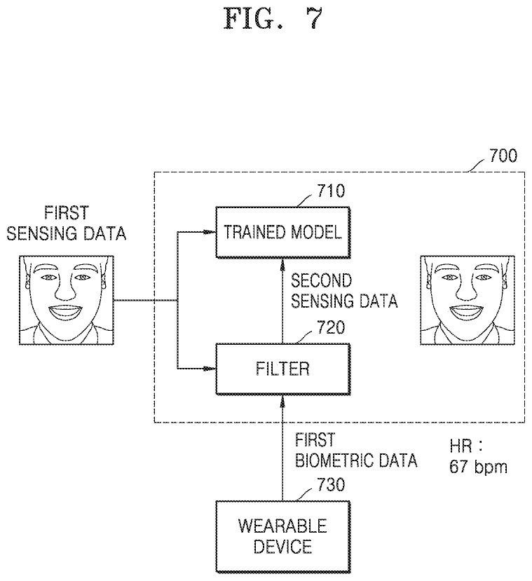

FIG. 7 is a diagram illustrating an example of training a trained model for estimating a user's physical condition by a device according to an embodiment of the disclosure. A device 700 of FIG. 7 may correspond to the mobile device 100 of FIGS. 1 to 6.

Referring to FIG. 7, the device 700 may be a device with a camera, and may be a device capable of analyzing a change of the skin color of a user's face to estimate heart rate information.

The device 700 may receive first biometric data from a wearable device 730 worn by the user. The first biometric data received by the device 700 may be real-time heart rate information of the user (for example, 67 bpm). The wearable device 730 may be a wearable device selected by the device 700 from among a plurality of wearable devices identified by the device 700. The wearable device 730 may be selected by the device 700 according to a degree of reliability of heart rate measurement.

The device 700 may obtain a face image of the user as the first sensing data. The device 700 may input the face image of the user (the first sensing data) and the real-time heart rate information of the user (the first biometric data) to a filter 720 thereof.

The filter 720 of the device 700 may obtain second sensing data related to the user's heart rate from the face image of the user (the first sensing data) based on the real-time heart rate information of the user (the first biometric data). The second sensing data may be data relating to the user's heart rate, and may be an image of a region of the user's face.

A trained model 710 for estimating a user's heart rate may be trained by the device 700 by using, as training data, the face image of the user (the first sensing data) and the image of the region of the user's face (the second sensing data).

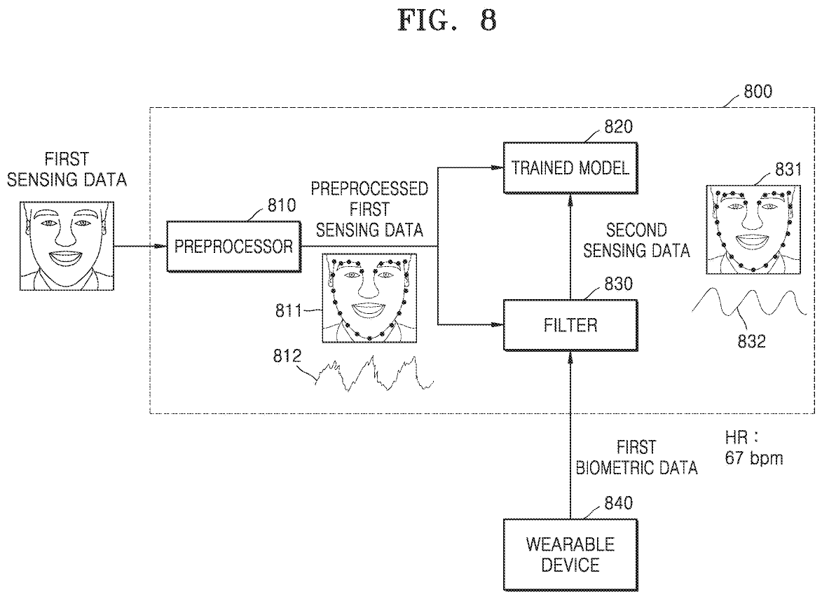

FIG. 8 is a diagram illustrating another example of training a trained model for estimating a user's physical condition by a device according to an embodiment of the disclosure. A device 800 of FIG. 8 may correspond to the mobile device 100 of FIGS. 1 to 6 and the device 700 of FIG. 7.

Referring to FIG. 8, a trained model 820, a filter 830, and a wearable device 840 of FIG. 8 may correspond to the trained model 710, the filter 720, and the wearable device 730 of FIG. 7, respectively.

The device 800 may receive first biometric data from the wearable device 840 worn by a user. The first biometric data received by the device 800 may be real-time heart rate information (e.g., 67 bpm) of the user. The device 800 may obtain a face image of the user as the first sensing data.

A preprocessor 810 may generate preprocessed first sensing data by preprocessing the face image of the user (the first sensing data). For example, the preprocessor 810 may generate an image including only the user's face (preprocessed first sensing data 811) by identifying the user's face in the face image of the user (the first sensing data).

Furthermore, the preprocessor 810 may generate a face image signal of the user (preprocessed first sensing data 812) by preprocessing the face image of the user (the first sensing data).

The device 800 may input the real-time heart rate of the user (the first biometric data) and the preprocessed first sensing data to the filter 830.

For example, the device 800 may input the real-time heart rate of the user (the first biometric data) and the image including only the user's face (the preprocessed first sensing data 811) to the filter 830. The device 800 may obtain image data of a region of the user's face related to the user's heart rate (second sensing data 831) from the image including only the user's face (the preprocessed first sensing data 811). The image data of the region of the user's face (the second sensing data 831) may be image data of an image including only the region of the user's face related to the user's heart rate.

The device 800 may input the real-time heart rate of the user (the first biometric data) and the face image signal of the user (the preprocessed first sensing data 812) to the filter 830. The device 800 may obtain a face image signal related to the user's heart rate (second sensing data 832) from the face image signal of the user (the preprocessed first sensing data 812). The face image signal related to the user's heart rate (the second sensing data 832) may be a signal of a specific frequency band. The specific frequency band may be a frequency band including a frequency band corresponding to the user's heart rate.

The trained model 820 for estimating a user's heart rate may be trained by the device 800 based on the image including only the user's face (the preprocessed first sensing data 811) and the image data of the region of the user's face (the second sensing data 831) as training data.

Alternatively, the trained model 820 for estimating a user's heart rate may be trained by the device 800 based on the face image signal of the user (the preprocessed first sensing data 812) and the face image signal related to the user's heart rate (the second sensing data 832) as training data.

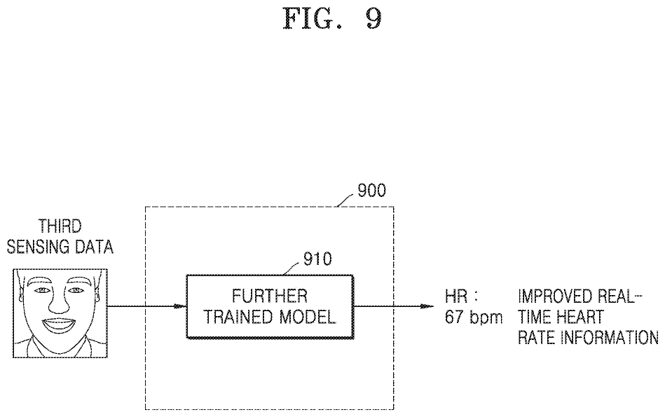

FIG. 9 is a diagram illustrating an example of estimating a user's physical condition using a further trained model by a device according to an embodiment of the disclosure. A device 900 of FIG. 9 may correspond to the mobile device 100 of FIGS. 1 to 6, the device 700 of FIG. 7, and the device 800 of FIG. 8.

Referring to FIG. 9, the device 900 may obtain a face image of a user as third sensing data. The device 900 may estimate real-time heart rate information of the user by applying the face image of the user (the third sensing data) to a further trained model 910. The further trained model 910 may estimate more improved real-time heart rate information than a trained model that has yet to be further trained.

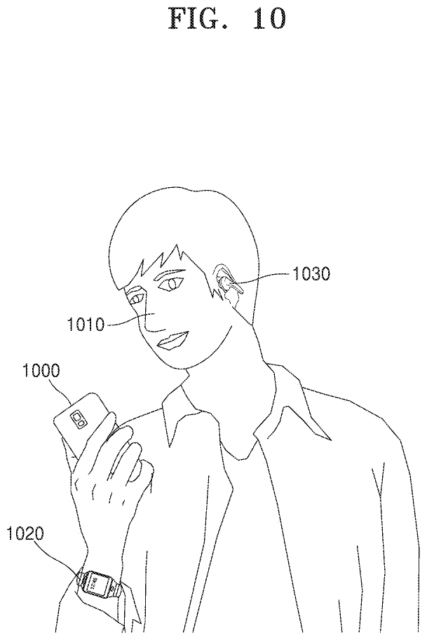

FIG. 10 is a diagram illustrating a situation in which a trained model for estimating a user's physical condition is trained by a device according to an embodiment of the disclosure.

FIG. 10 illustrates a situation in which, for example, a trained model for estimating a user's physical condition is trained by a mobile device 1000.

The mobile device 1000 of FIG. 10 may correspond to device 100 of FIGS. 1 to 6, the device 700 of FIG. 7, the device 800 of FIG. 8, and the device 900 of FIG. 9.

Referring to FIG. 10, a user's face 1010 may be photographed by a camera included in the mobile device 1000 while the user makes a video call using the mobile device 1000. The mobile device 1000 may obtain a face image of the user during the video call.

The mobile device 1000 may identify a plurality of wearable devices 1020 and 1030 worn by the user, and select the wearable device 1020 with a high reliability of heart rate measurement among the identified wearable devices 1020 and 1030.

The mobile device 1000 may receive real-time heart rate information of the user from the selected wearable device 1020. A trained model for estimating a user's heart rate may be trained by the mobile device 1000 based on the obtained face image of the user and the real-time heart rate information of the user as training data.

The training of the trained model for estimating a user's heart rate by the mobile device 1000 may be performed in a state in which the training of the trained model is not recognized by the user, e.g., during the video call. Therefore, the trained model may be trained by the mobile device 1000 even when the training thereof is not recognized by the user.

The trained model for estimating a user's heart rate may be trained by the mobile device 1000 even when the training thereof is not recognized by the user, thereby increasing the accuracy of heart rate estimation of the trained model.

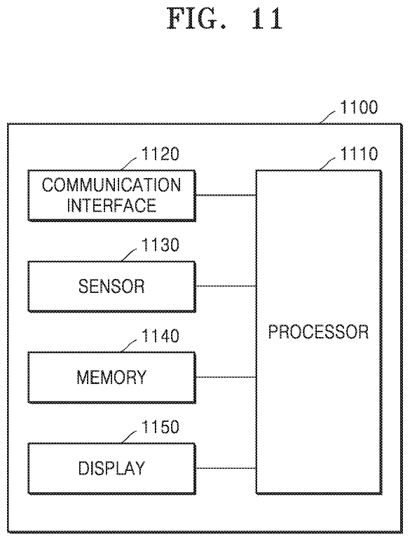

FIG. 11 is a block diagram illustrating a structure of a device according to an embodiment of the disclosure. A device 1100 of FIG. 11 may correspond to the mobile device 100 of FIGS. 1 to 6, the device 700 of FIG. 7, the device 800 of FIG. 8, the device 900 of FIG. 9, and the mobile device 1000 of FIG. 10.

The device 1100 illustrated in FIG. 11 may also perform the methods illustrated in FIGS. 2 to 6. Thus, it will be understood that, although not described below, the above description with reference to the methods of FIGS. 2 to 6 may be performed by the device 1100 of FIG. 11.

Referring to FIG. 11, the device 1100 according to an embodiment of the disclosure may include at least one processor 1110, a communication interface 1120, a sensor 1130, a memory 1140, and a display 1150. However, not all the components illustrated in FIG. 11 are indispensable components of the device 1100. The device 1100 may further include other components not illustrated in FIG. 11, or may include only some of the components illustrated in FIG. 11.

The processor 1110 may control the communication interface 1120, the sensor 1130, the memory 1140 and the display 1150, which will be described below, to allow the device 1100 to train and use a trained model for estimating a user's physical condition.

The processor 1110 may execute one or more instructions stored in the memory 1140 to control the communication interface 1120, the sensor 1130, the memory 1140, and the display 1150 which will be described below.

The processor 1110 may also execute one or more instructions stored in the memory 1140 to receive first biometric data, which is generated by a wearable device worn by a user, from the wearable device. The processor 1110 may execute one or more instructions stored in the memory 1140 to receive the first biometric data via the communication interface 1120.

The processor 1110 may also execute one or more instructions stored in the memory 1140 to obtain first sensing data to be used to estimate the user's physical condition through the sensor 1130 included in the device 1100.

The processor 1110 may also execute one or more instructions stored in the memory 1140 to train the trained model for estimating a user's physical condition based on the first biometric data and the first sensing data as training data.

The processor 1110 may also execute one or more instructions stored in the memory 1140 to input the first biometric data and the first sensing data to a certain filter so as to generate second sensing data related to the user's physical condition from the first sensing data.

The processor 1110 may also execute one or more instructions stored in the memory 1140 to train the trained model for estimating a user's physical condition based on the first biometric data and the second sensing data as training data.

The processor 1110 may also execute one or more instructions stored in the memory 1140 to preprocess the first sensing data. The processor 1110 may also execute one or more instructions stored in the memory 1140 to input the first biometric data and the preprocessed first sensing data to the filter so as to obtain the second sensing data related to the user's physical condition from the preprocessed first sensing data.

The processor 1110 may also execute one or more instructions stored in the memory 1140 to train the trained model for estimating a user's physical condition based on the second sensing data and the preprocessed first sensing data as training data.

The processor 1110 may also execute one or more instructions stored in memory 1140 to transmit a device search signal through short-range wireless communication. The device search signal may be transmitted by the processor 1110 via the communication interface 1120. The processor 1110 may receive response signals from a plurality of wearable devices in response to the transmitted device search signal. The response signals may be received by the processor 1110 via the communication interface 1120.

The processor 1110 may also execute one or more instructions stored in the memory 1140 to select at least one wearable device from among the plurality of wearable devices providing the response signals based on at least one of a degree of closeness between each of the wearable devices and the user's skin, a type of first biometric data generated by each of the wearable devices, or a signal-to-noise ratio (SNR) of a bio-signal obtained by each of the wearable devices and related to the first biometric data.

The processor 1110 may also execute one or more instructions stored in the memory 1140 to identify the user. The processor 1110 may train a trained model for estimating a physical condition corresponding to an identified user among a plurality of trained models.

The processor 1110 may also execute one or more instructions stored in the memory 1140 to obtain third sensing data by the sensor 1130. The processor 1110 may also execute one or more instructions stored in the memory 1140 to apply the obtained third sensing data to a further trained model so as to estimate the user's physical condition.

The communication interface 1120 may transmit a device search signal through short-range wireless communication. The communication interface 1120 may receive response signals from a plurality of wearable devices in response to the device search signal.

The sensor 1130 may obtain the first sensing data while not in contact with the user's body. The sensor 1130 may include at least one of a camera, a radar device, a capacitive sensor, or a pressure sensor. When the sensor 1130 is a camera, the sensor 1130 is capable of obtaining a face image of the user to be used for estimation of the user's heart rate.

The memory 1140 may store one or more instructions executable by the processor 1110. The memory 1140 may store the trained model for estimating a user's physical condition. In addition, the memory 1140 may store a trained model for estimating physical conditions of a plurality of users.

The display 1150 may display results of operations performed by the processor 1110. For example, the display 1150 may display information regarding a physical condition estimated by the device 1100 by using the trained model.

Although it is described above that the trained model for estimating a user's physical condition is trained by the device 1100 and the user's physical condition is estimated using the trained model, embodiments of the disclosure are not limited thereto.

The device 1100 may operate in connection with a separate server (not shown) to train the trained model for estimating a user's physical condition and estimate the user's physical condition by using the trained model.

In this case, for example, the server may perform the function of the device 1100 that trains the trained model for estimating a user's physical condition. The server may receive training data to be used for learning from the device 1100. For example, the server may receive, as training data, the first sensing data obtained by the device 1100 and the first biometric data received from the wearable device by the device 1100.

The server may preprocess the first sensing data received from the device 1100 and use the preprocessed first sensing data as training data.

The server may obtain the second sensing data by inputting the first sensing data and the first biometric data received from the device 1100 to a certain filter. Alternatively, the server may obtain the second sensing data by inputting the preprocessed first sensing data and the first biometric data to the filter. The server may use the obtained second sensing data as training data.

The server may train the trained model for estimating a user's physical condition based on training data received from the device 1100. Alternatively, the server may train the trained model for estimating a user's physical condition based on data obtained as training data by using data received from the device 1100.

The device 1100 may receive a trained model generated by the server from the server, and estimate the user's physical condition by using the received trained model. The trained model received by the device 1100 from the server may be a trained model learned by the server.

An operation method of the device 1100 may be recorded on a computer-readable recording medium having recorded thereon one or more programs, which may be executed in a computer, including instructions for executing the operation method. Examples of the computer-readable recording medium include magnetic media such as a hard disk, a floppy disk and a magnetic tape, optical media such as compact disk read only memory (CD-ROM) and digital versatile disc (DVD), magneto-optical media such as a floptical disk, and hardware devices, such as read only memory (ROM), random access memory (RAM), flash memory, and the like, which are specially configured to store and execute program instructions. Examples of the program instructions include not only machine language codes prepared by a compiler, but also high-level language codes executable by a computer by using an interpreter or the like.

While the disclosure has been shown and described with reference to various embodiments thereof, it will be understood by those y skilled in the art that various changes in form and details may be made therein without departing from the spirit and scope of the disclosure as defined by the appended claims and their equivalents.

What is claimed is:

1. A method of estimating a user's physical condition performed by a device, the method comprising:
receiving first biometric data from a wearable device worn by the user, the first biometric data being obtained by the wearable device;
obtaining first sensing data via a sensor included in the device, the first sensing data being used for estimation of the user's physical condition; and
training a trained model for estimating the user's physical condition based on an artificial intelligence algorithm and by using the received first biometric data and the obtained first sensing data as training data,
wherein the sensor obtains the first sensing data while not in contact with the user's body.

2. The method of claim 1, wherein the artificial intelligence algorithm comprises at least one of a machine learning algorithm, a neural network algorithm, a genetic algorithm, a deep-learning algorithm, or a classification algorithm.

3. The method of claim 1, wherein the training of the trained model for estimating the user's physical condition comprises:
obtaining second sensing data related to the user's physical condition from the first sensing data by inputting the first biometric data and the first sensing data to a certain filter; and
using the first sensing data and the second sensing data as the training data,
wherein the filter obtains the second sensing data related to the user's physical condition from the first sensing data based on the first biometric data.

4. The method of claim 3, further comprising:
preprocessing the first sensing data,
wherein the obtaining of the second sensing data comprises obtaining the second sensing data by inputting the first biometric data and the preprocessed first sensing data to the filter.

5. The method of claim 1, wherein the wearable device comprises a wearable device selected from among a plurality of wearable devices based on at least one of:
a degree of closeness between each of the plurality of wearable devices and the user's skin,
a type of first biometric data generated by each of the plurality of wearable devices, or
quality of a biometric signal obtained by each of the wearable devices and related to the first biometric data.

6. The method of claim 5, further comprising:
searching for the plurality of wearable devices through short-range wireless communication,
wherein the wearable device comprises a wearable device selected from among the searched plurality of wearable devices.

7. The method of claim 1, wherein the first biometric data is sensed by the wearable device in contact with the user's body.

8. The method of claim 1, wherein the received first biometric data and the obtained first sensing data are obtained together within a certain time period.

9. The method of claim 1, further comprising:
obtaining third sensing data by the sensor included in the device; and
obtaining information regarding the user's physical condition estimated using the further trained model by applying the third sensing data to the further trained model.

10. The method of claim 1, wherein the first sensing data is generated using at least one of a camera, a radar device, a capacitive sensor, or a pressure sensor included in the device.

11. A device for estimating a user's physical condition, the device comprising:
a communication interface;
at least one sensor;
a memory; and
at least one processor configured to:
control the communication interface to receive first biometric data, which is obtained by a wearable device worn by the user, from the wearable device,
control the at least one sensor to obtain first sensing data to be used for estimation of the user's physical condition, and
train a trained model for estimating the user's physical condition based on an artificial intelligence algorithm and by using the received first biometric data and the obtained first sensing data as training data,
wherein the at least one sensor obtains the first sensing data while not in contact with the user's body.

12. The device of claim 11, wherein the artificial intelligence algorithm comprises at least one of a machine learning algorithm, a neural network algorithm, a genetic algorithm, a deep-learning algorithm, or a classification algorithm.

13. The device of claim 11, wherein the at least one processor is further configured to:
obtain second sensing data related to the user's physical condition from the first sensing data by inputting the first biometric data and the first sensing data to a certain filter; and
train the trained model for estimating the user's physical condition based on the first sensing data and the second sensing data as the training data,
wherein the certain filter obtains the second sensing data related to the user's physical condition from the first sensing data by using the first biometric data.

14. The device of claim 13, wherein the at least one processor is further configured to:
preprocess the first sensing data, and
obtain the second sensing data by inputting the first biometric data and the preprocessed first sensing data to the filter.

15. The device of claim 11, wherein the wearable device comprises a wearable device selected from among a plurality of wearable devices based on at least one of:
a degree of closeness between each of the plurality of wearable devices and the user's skin,
a type of first biometric data generated by each of the plurality of wearable devices, or
quality of a biometric signal obtained by each of the wearable devices and related to the first biometric data.

16. The device of claim 15,
wherein the at least one processor is further configured to search for the plurality of wearable devices through short-range wireless communication, and
wherein the wearable device comprises a wearable device selected from among the plurality of searched wearable devices.

17. The device of claim 11, wherein the first biometric data is sensed by the wearable device in contact with the user's body.

18. The device of claim 11, wherein the received first biometric data and the obtained first sensing data are obtained together by the device within a certain time period.

19. The device of claim 11, wherein the at least one processor is further configured to:
obtain third sensing data via a sensor included in the device, and
obtain information regarding the user's physical condition estimated using the further trained model by applying the third sensing data to the further trained model.

20. A computer-readable recording medium storing a program that, when executed by one or more processors, cause the one or more processors to perform operations comprising:
receiving first biometric data from a wearable device worn by a user, the first biometric data being obtained by the wearable device;
obtaining first sensing data via a sensor included in the wearable device, the first sensing data being used for estimation of the user's physical condition; and
training a trained model for estimating the user's physical condition based on an artificial intelligence algorithm and by using the received first biometric data and the obtained first sensing data as training data,
wherein the sensor obtains the first sensing data while not in contact with the user's body.
